(19) United States
(12) Patent Application Publication
(10) Pub. No.: US 2010/0204441 A1
(43) Pub. Date: Aug. 12, 2010

(54) MEANS FOR AND METHODS OF PROCESSING SUPERFINE DRY POLYMER

(76) Inventor: Dennis G. PARDIKES, Palos Park, IL (US)

Correspondence Address: ICE MILLER LLP, ONE AMERICAN SQUARE, SUITE 3100, INDIANAPOLIS, IN, 46282-0200, US

(21) Appl. No.: 12/698,754

(22) Filed: Feb. 2, 2010

Related U.S. Application Data
(63) Continuation-in-part of application No. 11/562,700, filed on Nov. 22, 2006, now abandoned.
Application No. 11/562,700 is a continuation of application No. 10/172,127, filed on Jun. 14, 2002, now abandoned.
(60) Provisional application No. 60/298,306, filed on Jun. 14, 2001.

(51) Int. Cl. C08F 6/00

(52) U.S. Cl. 528/499

(57) ABSTRACT

Superfine dry polymer particles (about 70-400 mesh, mean average) are hydrated while in a highly energized turbulence. The dry particles are metered at a rate which separates the particles at the time when they first strike a solvent. The turbulence of the mixed particles and a solvent (preferably water) further separates and wets the particles.

This application is a continuation-in-part of U.S. patent application Ser. No. 11/562,700, filed Nov. 22, 2006, which is a continuation of U.S. patent application Ser. No. 10/172,127, filed Jun. 13, 2002, which claims priority from U.S. Provisional Application No. 60/298,306, filed Jun. 14, 2001, each of which are incorporated herein by reference in their entirety.

This invention relates to means for and methods of processing superfine dry polymer and more particularly to processing polymer particles in the appropriate range of 70-400 mesh (mean average and still more particularly in a preferred range of 120-220 mesh (mean average).

The term “mean average” is defined as the mid-range size of a particle distribution described by a Gaussian or bell-shaped curve. Usually, a manufacturer determines the particle size of his polymer product by passing it through a series of screens before shipping it. In one example, a manufacturer may choose to limit the range of particle sizes to those particles which cannot pass through either a 10 mesh screen on the large end of the range or a 100 mesh screen on the small end of the range. In this example, the “mean average” is about 40-60 mesh, or ideally 55 mesh. In a second example, the two screens may be 40 and 100 mesh. In this second example, the ideal average particle size is 70 mesh.

The following table gives particle size in terms of U.S. mesh, inches and microns:

| U.S. Mesh | Inches | Microns |
|---|---|---|
| 10 | 0.787 | 2000 |
| 40 | 0.0165 | 420 |
| 100 | 0.0059 | 149 |
| 120 | 0.0049 | 125 |
| 140 | 0.0041 | 105 |
| 230 | 0.0024 | 63 |
| 325 | 0.0017 | 44 |
| 400 | 0.0015 | 37 |

The manufacturers who use the polymers processed as described herein provide screens at the input of their systems. These screens remove contaminants from the in-flowing bulk polymers. These contaminants may be almost anything, such as packaging material (string, staples, plastic bits, things picked up in the manufacturer's plant, etc.). These screens will also remove any polymer particles which are too large, contaminated by moisture, of an unusable size, etc. which do not fit the manufacturer's needs.

The current art of processing dry polymers for liquid/solids separation involves the use of a system designed to meter a dry form of polymer granules (about 40-50 mesh, mean average) into a solvent wetting device. Preferably the solvent will be water, although non-aqueous solvents may be used where appropriate for the polymer being used and then to transport the mixture of wetted polymer into a mixing tank. There the polymer is mechanically agitated to hydrate or dissolve it into a solution. This solution may be used in any of a number of applications designed to take advantage of the unique polymer molecular structure and charge characteristics. Some examples of these applications include wastewater treatment, parpermaking and mineral recovery. Other examples of uses for the polymer solution will readily occur to those skilled in the art.

Due to the granular or particle nature of the polymers, prior processing systems require a substantial mixing time to thoroughly dissolve the polymers. An addition of large mixing and holding tanks provides enough capacity and time for this thorough dissolving to occur. Hence, the average time required heretofore to complete this process can range from 1 to 2 hours. A significant share of the time required to complete dissolution is attributed to the mixing phase.

The average processing cycle is broken down into three components: the fill, mix and transfer stages. During the fill stage, the mixing tank is charged with both water and polymer. The mixing stage utilizes a large mechanical turbine, a recirculation device, or propeller mixers to agitate the polymer particles suspended in the water until most are dissolved. The transfer stage removes the hydrated solution from the mixing tank and directs it to a holding tank where the solution is held while the polymer particles continue dissolving in order to reach a substantially homogenous state. In general, for the prior art, the fill stage takes about 20-30 minutes, the mixing stage about 40-120 minutes, and the transfer stage about 10-15 minutes.

The critical portion of processing dry polymer particles focuses on the moment of particle wetting. The dry polymer particles must be individually wetted to prevent the formation of agglomerations or fisheyes. Once formed, agglomerations do not dissolve very well; therefore, they must be filtered out of the solution before the polymer can be used. This requirement to eliminate agglomerations or fisheyes is wasteful and sometimes disruptive for sensitive operations, such as papermaking.

My U.S. Pat. Nos. 5,599,101 and 5,879,080 describe an apparatus for and processes of fully wetting polymer granules or particles. In greater detail, a processing module with a rotor assembly receives the dry polymer particle flow and disperses it into a solvent, such as water, in a high-energy state in order to achieve a maximum separation on impact with the solvent or water at the moment of wetting. Then, this mixture is immediately transferred to the mixing tank for further dissolution. There are a number of other devices that use alternative processes of wetting the polymer that achieve similar results,

An important aspect of the process of wetting polymer particles is the nature or rheology of the dry polymer particle itself. The polymer particles must have a size which is large enough to lend themselves to the wetting process. Heretofore, polymer manufacturers have gone to the extent of removing the smaller particles in order to improve the wetting process. To further improve the results, some polymer manufacturers make their particles round while others stay with irregular surfaces. However, substantially, all of the manufacturers hold to a specific and relatively large mesh size in order to assure good wetting characteristics.

Heretofore, when the polymer particle is too small, the wetting results are poor and agglomerations or fisheyes form. This is believed to be due to the hydrophilic nature of the polymer particles, which surround themselves with water at the moment of contact between the polymer particles and water. The smaller the particles, the larger the surface area for their size. Essentially, chemical and electrical forces keep the water from penetrating the outer surface of the agglomeration so that the particles in the center of the agglomeration remain dry and the agglomerates are effectively insoluble. Thus, large groups of very small particles tend to become trapped together (agglomerate) in a droplet of water and thus do not completely wet. Filtration of the polymer solution is commonly required to remove the agglomerates before the solution can be used in downstream applications.

The potential for this agglomeration or fisheyes to occur is proportional to the particle size. The larger the particles, the less the agglomerates; the smaller the particles, the more the agglomeration, etc. In the case of superfine particles (i.e. polythers having a mean average particle size of about 70 mesh or smaller) the problem of agglomeration is so severe that superfine polymers cannot be used for making polymer solutions using conventional processes. Accordingly, polymer manufacturers often go to great lengths to screen and eliminate small particles from the polymer manufacturing process. In light of this, superfine polymers are not considered commercially useful and conventional practice in the industry is restricted to the use of polymer particles of about 40-50 mesh, mean average.

However, the screening of smaller particle sizes is inconvenient because the time required to completely wet the particle increases with the increase of the particle size. If the smaller particles are wetted properly such that agglomerates do not form, a great deal of dissolving time is saved. As an example of the problem, consider a block of ice floating in a bucket of water. This would represent a standard “large” polymer particle. Now consider a handful of snow (representing “small” polymer particles) tossed into a bucket of water. Which will dissolve first? Although the chemical make-up of the snow and ice is identical, the snow will “dissolve” first due to its greater surface area resulting from its smaller particle size. In fact, the rate of small particle dissolution could easily be 100 times faster than the dissolution rate for a “large” particle.

If properly wetted, all soluble dry polymer particles act in generally the same manner. If the particle is small enough and wetted properly to eliminate agglomerations, the increase in surface area enables the polymer to hydrate (or dissolve in a non-aqueous solvent) 30 to 120 times faster than the hydration of larger particles wetted by a conventional processing process.

An impediment to achieving this kind of superior performance has been the unmet need for a wetting device capable of handling “superfine” polymer particles. Overcoming this impediment is important because, while polymer manufacturers do not currently offer superfine polymers for sale, many polymer manufacturers could provide their dry polymer in a superfine particle size grade. The specification for superfine particles is in a range in the order of 70 to 400 mesh, and more particularly in a range of 120-220 mesh (all mean average). By comparison, as previously noted, a more conventional polymer specification range used heretofore is about 40 to 50 mesh, mean average.

In keeping with this invention, an auger system meters the superfine dry polymer into the wetting module which houses a rotor device. The wetting module thoroughly wets the superfine particles and hydraulically transports them to a holding tank. No additional mixing is usually required; or, at the discretion of the user, a small tank mixer may be added in the line transporting the wetted particles. In either case, the polymer solution is typically ready to use almost instantly upon exiting the wetting module. Through use of the described method, cationic polymers have been found to hydrate in less than a minute and anionic polymers in a range of about 4-6 minutes. Furthermore, if warm water is used, hydration may be virtually instantaneous. This rapid hydration represents a 40-120 fold improvement over conventional means for hydrating polymers. In this case, the processed polymer solution may be sent in line directly to the end user process without the need or use of any mixing, holding, or other tanks.

The temperature of the water has an effect upon processing time and therefore, may be a controlling parameter. Processing usually is possible in the approximate temperature range of 33-180° F., but that wide a range is not always optimal. It has been found that a preferred range is between about 80°-100° F. for most polymers; however, it is contemplated that the optimal temperature to facilitate the dissolution of any particular polymer can be determined through a few trial runs.

### BRIEF DESCRIPTION OF DRAWINGS

FIG. 1 is a schematic drawing of an exemplary showing of a prior art layout for a conventional polymer processing system;

FIG. 2 is a bar graph chart showing the duty cycle of the prior art system of FIG. 1;

FIG. 3 is a schematic layout drawing of the inventive system which can out perform the prior art system of FIG. 1;

FIG. 3A is a fragment of FIG. 3 showing a shroud for protecting against environmental dust, drafts and the like, as well as a safety shield protecting both the workers and the machine;

FIG. 4 is a bar graph chart showing the duty cycle of the inventive system of FIG. 3; and

FIG. 5 is a timing chart contrasting the processing time required for the inventive system (solid line) with the processing time for the prior art system (dashed line).

### SUMMARY

Although heretofore it was thought to be difficult and time-consuming to hydrate superfine polymer, I have found that the system shown in my prior patents (U.S. Pat. Nos. 5,559,101 and 5,879,080, which are incorporated herein by reference), and sold under the trademark “POWDERCAT” model NP-250 Dry Polymer System by Norchem Industries, Ridgepoint Tech Center, 8910 W. 192nd Street, Mokena, Ill. 60448, can do so quickly and effectively. This system is designed to meter a dry form of polymer, to dynamically wet the polymer with a solvent, and thereafter to transfer the wet polymer and solvent mixture using a motorized disperser capable of processing 0-8 lbs/minute of dry polymer at 50 gpm to an agitated mix tank. This system has a modular design including a volumetric feeder, a motorized polymer processing module (“PPM”), a secondary dilution header, an inlet water valve, and a pressure sensor, all of which are integrally mounted in a stainless steel frame and a mechanically agitated liner. The system is designed to feed and transfer a polymer/polymer mixture without the use of reserve pumps or pneumatic blowers. In contrast to conventional methods where the problem of agglomeration prohibits the use of superfine polymers, the process employed by use of the described system unexpectedly eliminates the formation of agglomerates and the need for subsequent filtration.

The polymer processing module preferably has an all stainless steel housing with upper and lower flow chambers. The lower chamber contains a hermetically sealed stainless steel motor and housing assembly designed for chemical duty service. The upper chamber contains a flow divider, weir and induced air scrubber to contain small polymer dust particles. The polymer falls directly into the center of a rotor for creating a rapid dispersion and wetting of the polymer. No pre-wetting of the polymer is either required or permitted. At no time is the rotor hydraulically enveloped. The control panel contains a programmable logic controller, contactors for all motors, agitators and transfer devices, circuit breakers, phase loss monitors, motor drives, relays, times and level control circuits necessary for the proper operation of the system.

### DETAILED DESCRIPTION

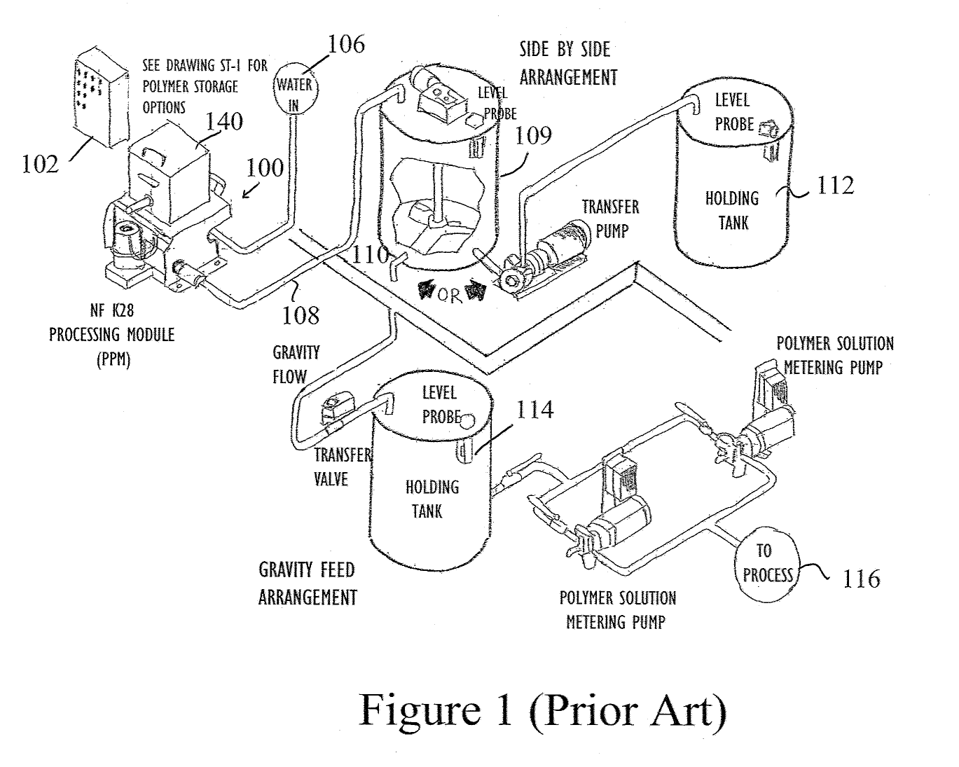

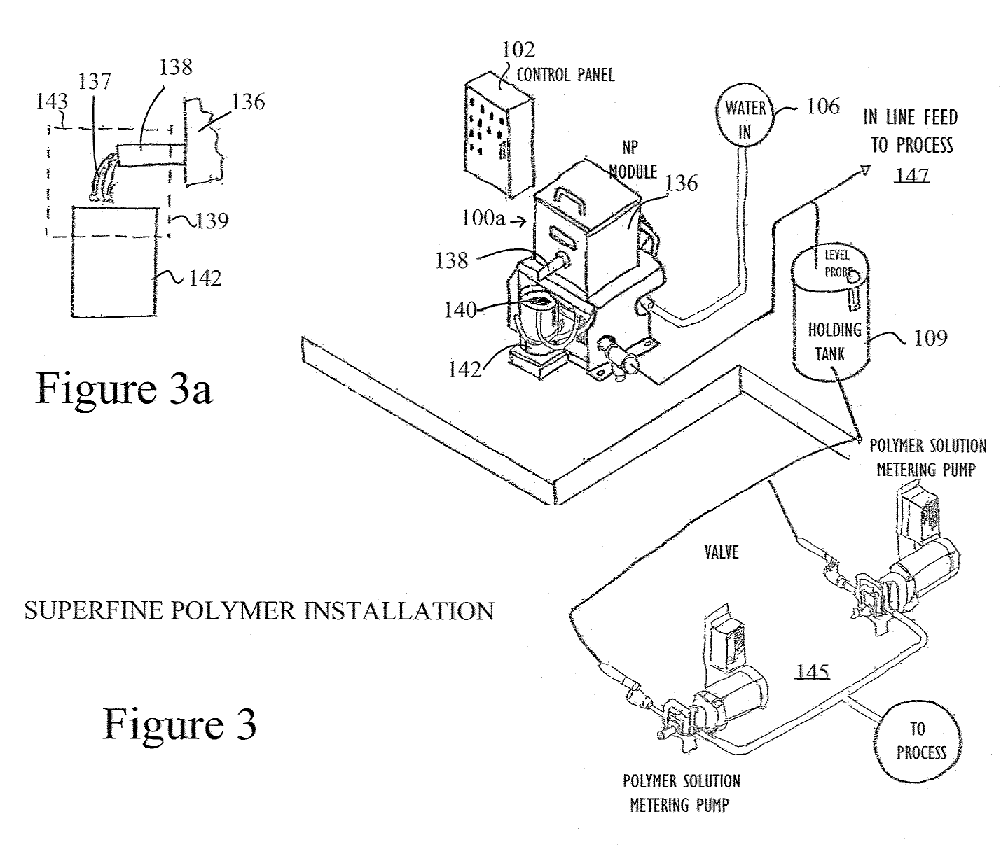

By way of comparison and contract, FIG. 1 shows a relatively large prior art system which can process, perhaps a maximum of 19 or 24, batches of polymer per day. The present day cost of such a system could be in the order of $100,000, or more. FIG. 3 shows the inventive system which has approximately half of the cost of the system in FIG. 1. This inventive system is capable of continuously processing superfine polymer which increases the outflow of processed polymer by 40-120 fold, which is quite unexpected. Also, the inventive system may be used on a high/low basis. When a tank of the processed polymer falls to a low point, the system starts operating. When the polymer in the tank reaches a high level, the system shuts down. If the inventive system feeds a production line capable of continuously using the full processed polymer output, the system operations continuously.

The prior art system for dissolving larger particle size polymers has a polymer processing module (“PPM”) 100 operating responsive to control panel 102. Polymer in a hopper 104 is mixed with water from source 106 until the polymer is thoroughly wetted. The thoroughly wetted polymer is transported over line 108 to a mixing tank 109 where a large agitator, recirculation device, propeller or other stirring device 110 (FIG. 1) agitates the wet polymer as it goes into a more homogenous solution. Once dissolved, the polymer is either pumped or drained into a holding tank 112 or 114. The polymer solution can then be pumped to a processor 116 for any suitable end use.

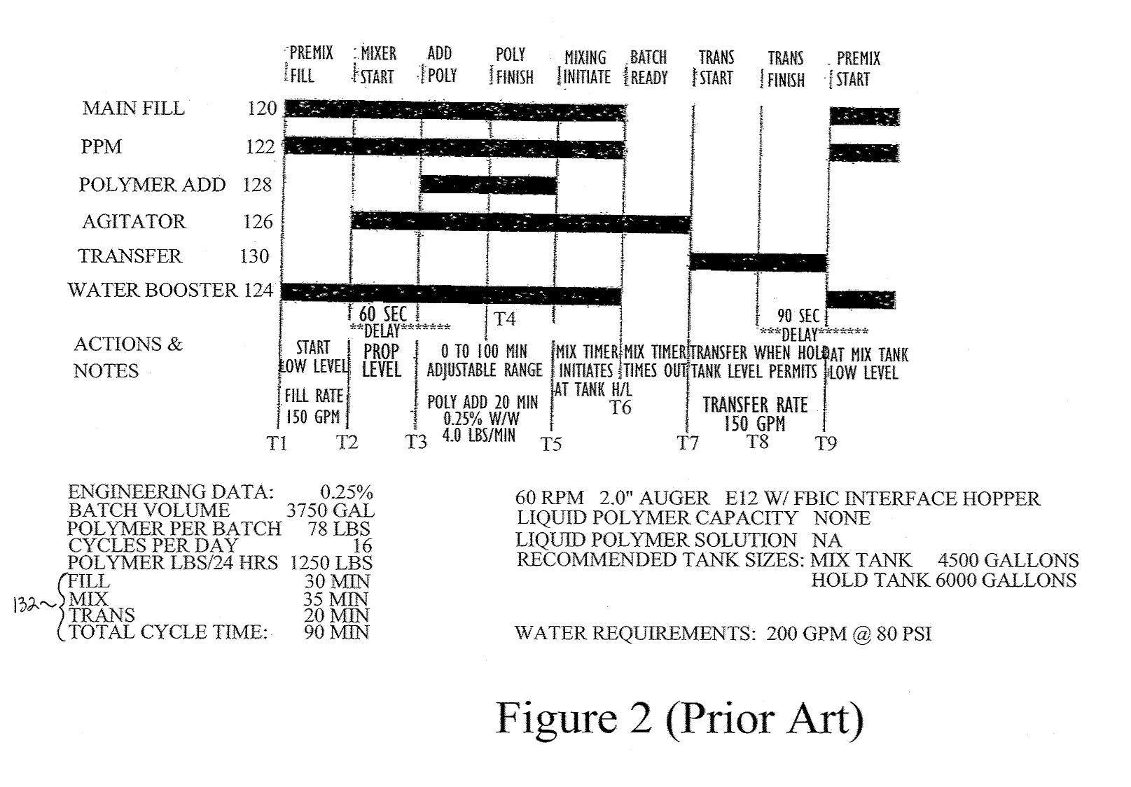

FIG. 2 is a bar graph which shows the duty cycle of the system of FIG. 1. Time is plotted on a horizontal axis. At time T1, water is added, as shown at 120; the polymer processing module begins to run, as shown at 122; and a water booster pump is started, as shown at 124. Next, an agitator is started at time T2, as shown at 126. At time T3, after the agitator has prepared the water or other solvent, the polymer granules or particles may be added into module 100, as shown at 128.

The time T4 is a time period which is adjustable to fit the requirements of the polymer being processed. At time T6, the introduction of water 106 into the main fill tank, operation of the polymer processing module 100 and the water booster pump stop. However, the agitator continues to run in order to prevent the polymer from settling out of the solution.

At time T7 and as shown at 130, the solution is transferred to the holding tank 112 or 114 where it is held until it reaches the desired state. The time T8 is adjustable to match the requirements of the holding tank.

This batch of polymer is completely processed at time T9, but a holding period has just begun. The next batch beings the same duty cycle at time T9.

At 132, the timing segments of the duty cycle are shown for an exemplary polymer. Without reference to the time spent in the holding tank, it has taken 90 minutes in this example for the polymer processing to advance from time T1 to time T9. Some polymers may require more time, some less time. Thus, in this example, the average number of batches processed per day is about 16.

FIG. 3 shows the inventive system for processing superfine polymers. This system has many fewer parts relative to the systems of the prior art. The equipment is in nearly constant operation and can serve the needs of continuous end use processes. Thus, expensive equipment is not tied up during a batch holding time.

The superfine polymer processing module 100a is similar to the prior art processing module 100. The hopper 136 holds superfine (about 70-400 mesh, mean average) dry polymer particles, which can be limited to the appropriate size of about 70-400 mesh, mean average. For example, and without limitation, a polymer manufacturer can limit the dry polymer to the desired size by passing the dry polymer through at least one screen. Alternatively, it is contemplated that this screening step may be performed through any other means known in the art. The superfine dry polymer particles contained in the hopper 136 are metered through an auger 138. The auger speed is adjusted so that the polymer particles cascade down as a stream into the opening 140 and onto an impeller (not shown). Concurrently, a stream of water or solvent is caused to flow continuously through the lower chamber of the processing module 100a (the processor 142), thus creating a venturi effect or vacuum within the processor 142. This venturi effect captures airborne superfine polymer particles and pulls them through the opening 140 in polymer processing module 100a.

The key to superfine particle processing is believed to occur at the interface of the superfine polymer particles and the water or other solvent. At the time when the particles meet the water, the individual superfine particles are separated from each other by a combination of events. First, the rate at which the auger dispenses the particles is controlled so that the particles fall onto the impeller as separate elements instead of a clump of particles. Second, an impeller in module 100a is used to impart a suitable level of energy to the polymer particles. Accordingly, as the particles fall through the opening 140 of the polymer processing module 100a, the dry polymer particles hit the impeller before any wetting of the dry polymer occurs. When the dry polymer particles make contact with the impeller, it causes the stream of superfine particles to explode so that they become highly energized and put into turbulence in order to churn the particles when they first meet the water. Some have described this action as being similar to throwing dry sand into a rapidly rotating fan.

The inventive aqueous dispersion process is carried out with a continuous stream of water that forms an annular wetting zone inside the lower chamber of the polymer processing module 100a (processor 142), around the dry/liquid interface of the superfine polymer particle. The powerful “burst” provided by imparting energy to the polymer particles rapidly accelerates the dry polymer particles 137 and causes the particles 137 to fly apart. In at least one embodiment, the parameters of the process can be managed such that when the dry polymer particles 137 reach maximum separation, they move through the annular wetting zone interface that is positioned in a lower chamber of the polymer processing module 100a. Accordingly, at the time the dry polymer particles meet the water or solvent, each of the individual particles are separated from each other. In this manner, each superfine particle is almost instantaneously surrounded and penetrated by water, resulting in a nearly immediate, substantially complete dispersion. Further and as previously noted, because the water and/or solvent is highly energized, an induced air flow is created that sucks in the stream of dry polymer particles into opening 140 and eliminates the need for blowers, pumps, transport devices, and additional internal dust suppression or collection systems. The induced air flow scrubber traps polymer dust particles in the polymer processing module 100a, achieving substantially a 100% capture and wetting of even the finest dry superfine polymer particle that is used.

In addition to or apart from the processes described above, numerous different techniques may be used to impart a suitable level of energy to the polymer particles. Examples shown in U.S. Pat. Nos. 5,879,080 and 5,599,101 employ an impeller. Another device for energizing the polymer may include ultrasonic agitators. It is contemplated that almost any suitable device may energize the polymer particles provided that the end result gives a high level of separation of the polymer particles at the instant they are wetted.

After the polymer is processed in the polymer processing module 100a, it may take different paths, depending upon the end user's needs. If the end user employs a batch process, the processed polymer solution in module 100 is pumped into tank 109 where it is held until needed, at which time metering pumps 145 send a fixed amount of the processed polymer solution to the end use process.

If the end user employs a continuous process, the processed polymer solution is pumped from module 100a directly in line 147 to the end use process.

While the system does not require dust control within the polymer processing module 100a, it is desirable to protect the delivery stream of the polymer particles against external environmental dust, drafts, contaminants, and the like. This protection may be provided by a shroud 143 (FIG. 3A) placed over the polymer feed system. Preferably, this shroud 143 is a removable, transparent housing which is suitably and reliably attached to the polymer processing module 100 when in place. The shroud prevents environmental dust and other contaminants from mixing with the particles while falling into the polymer processing module 100a. The shroud is also a safety device which prevents people from placing their hands or foreign objects into the machine.

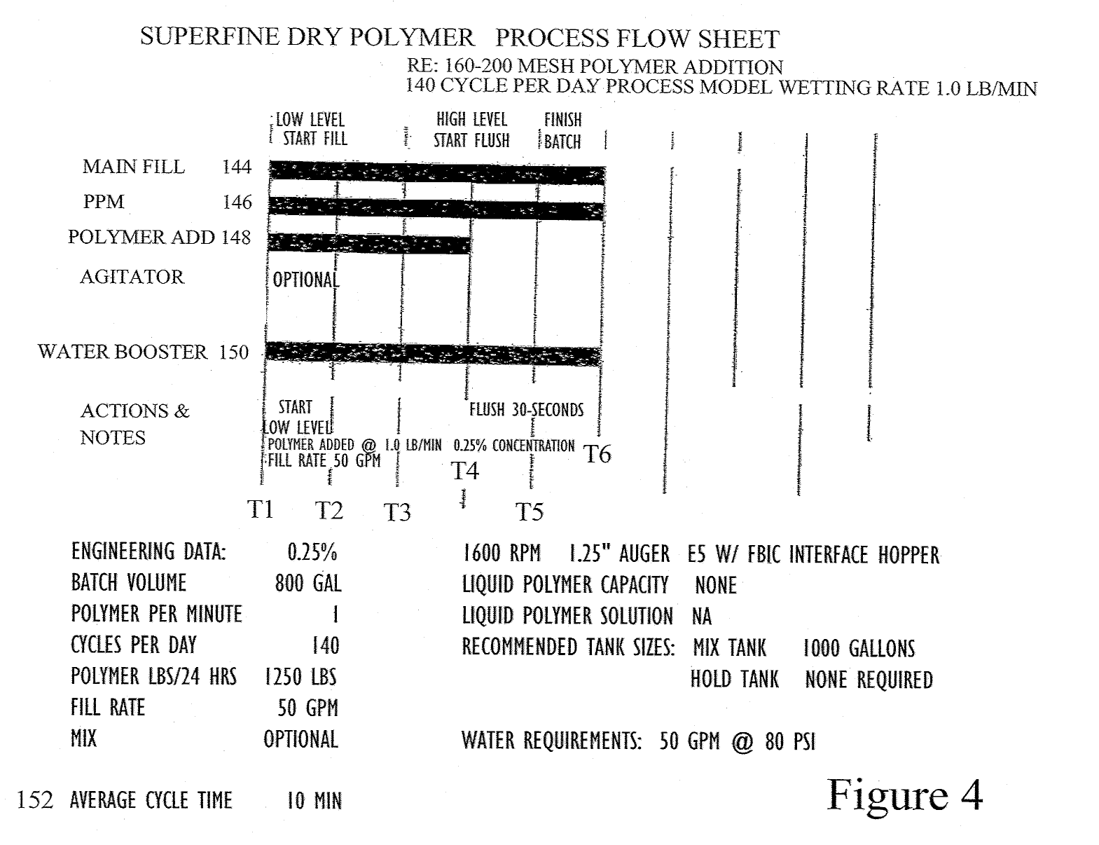

One duty cycle in the operation of the inventive system is shown in the bar graph of FIG. 4. The main tank fill, polymer processor module, addition of superfine polymer, and water booster begin simultaneously at T1, as shown at 144, 146, 148 and 150. Therefore, for an exemplary polymer, there is only the single time period of 10 minutes, as shown at 152, for the entire duty cycle. Again, some superfine polymers may take a little longer and some a little less.

With the described system, there may be in the order of 140 duty cycles per day as contrasted with the 16 duty cycles per day of the prior art system.

### Hydration Test:

A study was conducted to determine the hydration rates of the superfine polymer as compared to the hydrated rates for the standard polymer particle profile. Two control studies were conducted on the same polymer with identical charge and molecular weight characteristics, the only difference being the particle size. The polymer used in the studies was a dry particulate cationic polymer often used in paper mill retention applications. The normal procedure for determining the hydration is to measure the apparent viscosity developed over time.

As a polymer hydrates, the molecular conformation is altered by the charge interactions between the polymer and its solute (in this case, water). The molecular hydration increases the hydrodynamic volume of the polymer particle. This change in hydrodynamic volume can be measured indirectly by using a viscometer which measures the shear stress of the solution. The increase in hydrodynamic volume causes an increase in molecular entanglement resulting in a higher apparent viscosity. The viscometer used was a Brookfield Model LV fitted with a No. 1 spindle and run at 3 rpm.

A solution of PL 1420 polymer was prepared at 0.28% weight on weight by using a commercial grade product at approximately a 50-55 mesh average. A second solution was prepared in identical fashion using the same PL 1420 polymer, but further refined to a 160-180 mesh average.

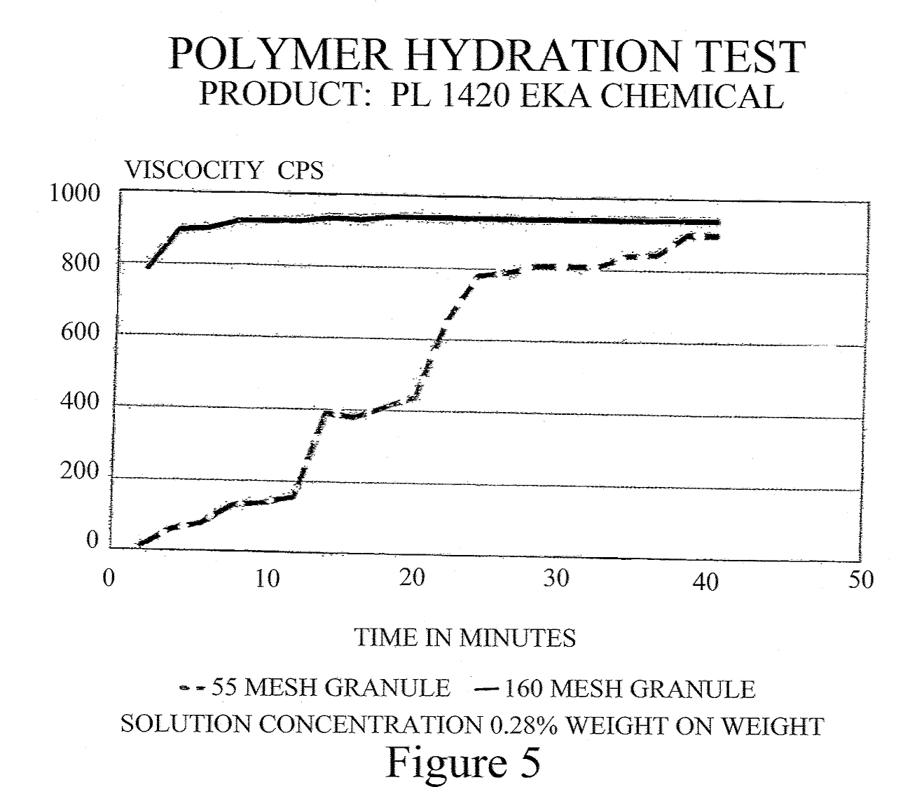

### Exhibit A (FIG. 5)

FIG. 5 is a graph showing the process (dashed line) of the prior art system as compared to the process (solid line) of the inventive system. The prior art system requires about 40 minutes to reach the 900 cps level. In about three or four minutes, the inventive system produces a polymer solution having a viscosity of about 900 cps. Long before the time that the prior art system reaches 900 cps, the inventive system will have reached about 930 cps. Hence, the inventive system is about 10 times faster and the end product is better than with the conventional system.

The results (FIG. 5) show an improvement in hydration time for the superfine polymer yielding a 2-5 minute profile as compared to a 30-40 minute profile for the standard preparation. The reduction in hydration time can be accounted for by the increase in surface area of the superfine product. In theory, even smaller particles (400+ mesh) should continue to improve hydration (dissolving) rates until solution becomes instantaneous at the moment of superfine polymer introduction in water. However, in practice, there might be diminishing returns with a further reduction of particle size. Furthermore, the cost for additional refining to achieve instant hydration might be excessive when compared to a slightly larger particle (100 to 330 mesh). In fact, the 160 mesh product shows a substantial savings in the cost of on-site processing equipment by significantly reducing hydration time.

The polymer processing began with a more or less standard process system for a typical dry polymer system, as disclosed in U.S. Pat. No. 5,599,101 to Pardikes and U.S. Pat. No. 5,879,080 to Pardikes (the “Powdercat System” NP 3150) as shown in FIG. 1.

The processing cycle begins with adding water into the substantially empty mix tank 109 (FIG. 1) until the tank mixer is covered with water. Automatic controls 102 start both the mixer and the volumetric feeder to meter the dry polymer 137 at a pre-established rate for a given time. When the high level is reached, the water shuts off and a timing circuit at 102 controls the agitator 110 as it is mixing and hydrating the polymer. At the end of 35-minutes (in this example) the contents of the mix tank 109 are transferred to the hold tank 112 for aging. This batch cycle then repeats automatically.

The superfine system of FIG. 3 has only a single tank 109 with an optional mixer (if desired). Additionally, the tank 109 is considerably smaller than the prior art tank in FIG. 1. This process adds polymer and water on demand between high and low level points in the hold tank. The solution enters the tank 109 at an operator selectable target concentration, usually between 0.1% and 2.0% polymer and is ready in a few minutes without additional processing. The advantages of the invention are less equipment, faster processing time, smaller tankage, and a smaller and less costly polymer processing module.

Those who are skilled in the art will readily perceive various modifications of the invention. Therefore, the appended claims are to be construed to cover all equivalents which fall within the scope and the spirit of the invention.

1. A process for dissolving dry water soluble polymers comprising the steps of:
(a) dispensing dry polymer particles in a downwardly falling stream, the dry polymer particles having a mean average size of about 70 to about 400 mesh;
(b) imparting energy to the dry polymer particles such that the dry polymer particles move apart from one another; and
(c) introducing the energized particles individually into a stream of solvent where each of the particles are hydrated.

2. The process of claim 1, in which the downwardly falling stream of particles is produced by a metering auger,

3. The process of claim 1, in which the stream of water creates an induced air flow that draws airborne dry polymer particles into the downwardly falling stream of particles.

4. The process of claim 1, in which the energy is imparted to the dry polymer particles by an ultrasonic agitator,

5. The process of claim 1 in which the energy is imparted to the dry polymer particles by a rotating impeller.

6. The process of claim 1, further comprising the step of agitating the stream of solvent to accelerate the rate of hydration of the energized polymer particles.

7. The process of claim 1, further comprising the step of providing a shroud to protect the downwardly falling stream of dry polymer particles from environmental contaminants.

8. The process of claim 1, further comprising the step of transporting the hydrated polymer particles to a mixing tank.

9. The process of claim 8, further comprising the step of agitating the hydrated polymer particles in the mixing tank to produce a substantially homogenous processed mixture.

10. The process of claim 9, further comprising the step of pumping a metered amount of the homogenous processed mixture to an end use batch process.

11. The process of claim 1 in which the hydrated polymer is pumped in line directly to a substantially continuous end use process.

12. The process of claim 1 in which the water is maintained at a temperature of about 33 to about 100° F.

13. The process of claim 1 in which the water is maintained at a temperature of about 80 to about 100° F.

14. A process for dissolving dry water soluble polymers comprising the steps of:
(a) dispensing dry polymer particles having a mean average particle size of about 70 to about 400 mesh in a downwardly falling stream;
(b) separating the dry polymer particles from each other by imparting energy to the dry polymer particles; and
(c) introducing the separated, energized dry polymer particles into a stream of solvent where each of the particles are hydrated.

15. The process of claim 1, further comprising the step of passing dry polymer particles through at least one screen to limit the size of the polymer particles to a mean average particle size of about 70 to about 400 mesh.

16. The process of claim 14 in which the stream of solvent is heated to a temperature of about 80 to about 100° F.

17. The process of claim 14 in which the downwardly falling stream is produced by a metering auger.

18. The process of claim 14 in which the stream of solvent creates an induced air flow that draws airborne dry polymer particles into the downwardly falling stream.

19. The process of claim 14 in which the energy is imparted to the particles by a rotating impeller.

20. The process of claim 14, further comprising the step of agitating the stream of solvent to accelerate the rate of hydration of the energized dry polymer particles.

21. A method of continuously processing a dry polymer to provide a polymer solution to an end use process, comprising the steps of:
(a) dispensing dry polymer particles in a downwardly falling stream, the dry polymer particles having a mean average size of about 70 to about 400 mesh;
(b) imparting energy to the dry polymer particles such that the dry polymer particles move apart from one another;
(c) introducing the energized particles individually into a stream of solvent where each of the particles are hydrated to form a polymer solution; and
(d) outputting the polymer solution to an end use process.

22. The method of claim 21, wherein step (c) and step (d) are performed without the intermediate step of transferring the polymer solution of step (c) to a holding tank.

23. The process of claim 21, wherein the process is performed continuously.
